(19) United States
(12) Patent Application Publication
(10) Pub. No.: US 2023/0261311 A1
(43) Pub. Date: Aug. 17, 2023

(54) SECONDARY BATTERY INCLUDING VENTING PART

(71) Applicant: LG ENERGY SOLUTION, LTD., Seoul (KR)

(72) Inventors: Jin Min PARK, Daejeon (KR); Joo Hwan SUNG, Daejeon (KR); Kyung Hwan JUNG, Daejeon (KR)

(21) Appl. No.: 18/109,027

(22) Filed: Feb. 13, 2023

(30) Foreign Application Priority Data
Feb. 14, 2022 (KR) 10-2022-0018633

(51) Int. Cl. H01M 50/342; H01M 50/103; H01M 50/55; H01M 50/548

(52) U.S. Cl. CPC H01M 50/3425; H01M 50/103; H01M 50/55; H01M 50/548

(57) ABSTRACT

A prismatic secondary battery includes a battery case including six flat surfaces that are first to sixth surfaces to form a hexahedral shape, the first and third surfaces having an area wider than the second and fourth surfaces, and the fifth and sixth surfaces having the widest area. A positive electrode terminal and a negative electrode terminal are disposed on at least one surface of the first, second, and fourth surfaces; and a venting part is disposed on the third surface.

### TECHNICAL FIELD

The present disclosure relates to a secondary battery including a venting part, and particularly, to a prismatic secondary battery having a hexahedral shape.

### BACKGROUND

Secondary batteries are rechargeable unlike primarily batteries, and due to the possibility of a compact size and a high capacity, a lot of research on secondary batteries is being carried out. Due to technology development and an increase in demand for mobile devices and also due to electric vehicles and energy storage systems that are emerging in line with the needs of the times for environmental protection, the demand for secondary batteries as energy sources is more rapidly increasing.

Secondary batteries are classified into coin type batteries, cylindrical type batteries, prismatic type batteries, and pouch type batteries according to a shape of a battery case. In such a secondary battery, an electrode assembly mounted in a battery case is a chargeable and dischargeable power generating device having a structure in which an electrode and a separator are stacked.

An electrode assembly may be approximately classified into a jelly-roll type electrode assembly in which a separator is interposed between a positive electrode and a negative electrode, each of which is provided in the form of a sheet coated with an active material, and then, the positive electrode, the separator, and the negative electrode are wound, a stack type electrode assembly in which a plurality of positive and negative electrodes with a separator interposed therebetween are sequentially stacked, and a stack/folding type electrode assembly in which stack type unit cells are wound with a separation film having a long length.

Regarding prismatic secondary batteries among various types of secondary batteries, in most prismatic secondary batteries, a positive electrode terminal and a negative electrode terminal are disposed together on one surface, or one positive electrode terminal and one negative electrode terminal are each disposed on one of two surfaces facing each other. In addition, in general, a venting part provided for the safety of a secondary battery is disposed between a positive electrode terminal and a negative electrode terminal disposed together on one surface or is disposed near each of the electrode terminals on both facing sides.

There is no particular problem in an arrangement of a venting part when a secondary battery operates normally. However, when internal pressure of the secondary battery is abnormally increased and the venting part is broken and gas is discharged, adjacent electrode terminals can be damaged. That is, when the venting part is broken and internal gas is ejected, a positive electrode terminal and a negative electrode terminal are damaged by corrosion, ignition, and the like, and the damage to the electrode terminals causes an electrical problem. Thus, it is highly likely that damage will not be limited to secondary batteries only. That is, when an electronic circuit of a module/pack is positioned at a position at which a terminal portion is positioned, a risk of explosion due to malfunction of the electronic circuit during venting is increased.

### SUMMARY

The present disclosure is directed to providing a prismatic secondary battery capable of effectively responding to damage and deterioration of electrode terminals caused by ejection of internal gas due to the breakage or opening of a venting part provided in a secondary battery.

However, the technical objects to be solved are not limited to the above, and other objects that are not described herein should be clearly understood by those skilled in the art from the following descriptions of the present disclosure.

A prismatic secondary battery comprises a battery case including six flat surfaces that are first to sixth surfaces to form a hexahedral shape, the first and third surfaces having an area wider than the second and fourth surfaces, and the fifth and sixth surfaces having the widest area; a positive electrode terminal and a negative electrode terminal which are disposed on at least one surface of the first, second, and fourth surfaces; and a venting part disposed on the third surface.

The positive electrode terminal and the negative electrode terminal may be disposed on the first surface.

Alternatively, the positive electrode terminal may be disposed on one of the second surface and the fourth surface, and the negative electrode terminal may be disposed on a remaining of the second surface and the fourth surface.

### Advantageous Effects

In a prismatic secondary battery having the above configuration, because an electrode terminal and a venting part are separated from one another by different surfaces, and in particular, the venting part being located at a bottom surface where a discharge from the venting part is discharged downward and pulled to the ground by gravity, prevents any discharge from making contact with the electrode. Therefore, without a change in internal structure of an existing prismatic secondary battery, a development period and production costs of the prismatic secondary battery may be reduced.

However, the technical effects obtainable through the present invention are not limited to the above-described effects, and other effects that are not described herein will be clearly understood by those skilled in the art from the following descriptions of the embodiments of the present invention.

### BRIEF DESCRIPTION OF THE DRAWINGS

The accompanying drawings illustrate exemplary embodiments of the present invention and, together with the following detailed description, serve to provide further understanding of the technical spirit of the present invention. However, the present invention is not to be construed as being limited to the drawings.

FIG. 1 is a view illustrating an example of a prismatic secondary battery 100 having a problem to which a solution of the present disclosure is applied.

FIG. 2 is a view illustrating an example of a prismatic secondary battery 100 having a problem to which a solution of the present disclosure is applied.

FIG. 3 is a view illustrating an example of a prismatic secondary battery 200 to which an embodiment of the present invention is applicable.

FIG. 4 is a view illustrating an example of a prismatic secondary battery 200 to which another embodiment of the present invention is applicable.

While the present invention may be variously changed and have various embodiments, specific embodiments will be described in detail below.

However, it should be understood that there is no intention to limit the present invention to the particular embodiments disclosed, and on the contrary, the present invention is to cover all modifications, equivalents, and alternatives falling within the spirit and scope of the claims.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

Also, when a portion such as a layer, a film, an area, a plate, etc. is referred to as being “on” another portion, this includes not only the case where the portion is “directly on” another portion but also the case where still another portion is interposed therebetween. On the other hand, when a portion such as a layer, a film, an area, a plate, etc. is referred to as being “under” another portion, this includes not only the case where the portion is “directly under” another portion but also the case where still another portion is interposed therebetween. In addition, to be disposed “on” in the present application may include the case disposed at the bottom as well as the top.

The present disclosure relates to a prismatic secondary battery that comprises a battery case including six flat surfaces that are first to sixth surfaces to form a hexahedral shape, the first and third surfaces having an area wider than the second and fourth surfaces, and the fifth and sixth surfaces having the widest area; a positive electrode terminal and a negative electrode terminal which are disposed on at least one surface of the first, second, and fourth surfaces; and a venting part disposed on the third surface.

The positive electrode terminal and the negative electrode terminal may be disposed on the first surface.

Alternatively, the positive electrode terminal may be disposed on one of the second surface and the fourth surface, and the negative electrode terminal may be disposed on a remaining of the second surface and the fourth surface.

Hereinafter, specific embodiments of a prismatic secondary battery of the present invention will be described with reference to the accompanying drawings. For reference, front, rear, left, and right directions or up and down directions for designating relative positions used in the description of each embodiment are used to help the understanding of the present invention and are based on directions shown in the drawings unless not specifically defined.

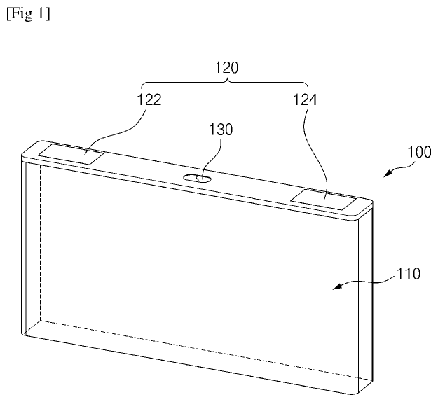

FIG. 1 is a view illustrating an example of a prismatic secondary battery 100 having a problem to which a solution of the present disclosure is applied. The prismatic secondary battery 100 of FIG. 1 corresponds to a unidirectional secondary battery in which electrode terminals 120 including a positive electrode terminal 122 and a negative electrode terminal 124 are disposed together on an upper surface of a battery case 110.

A venting part 130 is also disposed on the upper surface of the battery case 110. In the illustrated example, the venting part 130 is positioned between the positive electrode terminal 122 and the negative electrode terminal 124. The venting part 130 corresponds to a safety device which discharges gas when internal pressure of the prismatic secondary battery 100 increases to a certain level or more. However, when the venting part 130 and the electrode terminal 120 are positioned on the same surface of the battery case 110, the electrode terminal 120 is highly likely to be damaged by corrosion, ignition, and the like when the venting part 130 is broken and internal gas is ejected.

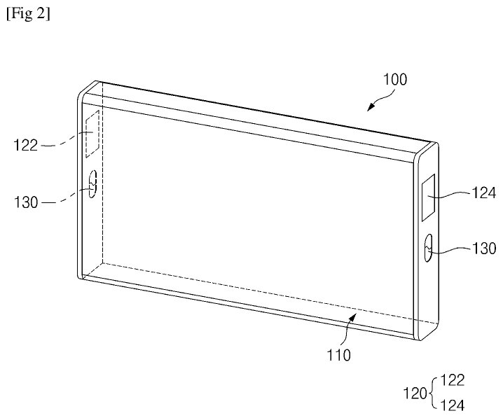

FIG. 2 is a view illustrating an example of a prismatic secondary battery 100 having a problem to which a solution of the present disclosure is applied. The illustrated prismatic secondary battery 100 corresponds to a bidirectional secondary battery 100 in which electrode terminals 120 including a positive electrode terminal 122 and a negative electrode terminal 124 are divided and each disposed on one of two side surfaces of a battery case 110. Specifically, in the prismatic secondary battery 100, the positive electrode terminal 122 and the negative electrode terminal 124 are each disposed on one of two side surfaces of the battery case 110, and two venting part 130, each disposed on respective one of two sides of the battery case 110. When the venting part 130 and the electrode terminal 120 are positioned on the same surface of the battery case 110, the electrode terminal 120 is highly likely to be damaged by corrosion, ignition, and the like when the venting part 130 is broken and internal gas is ejected.

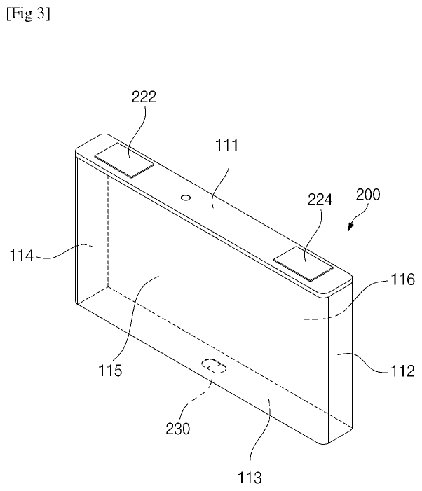

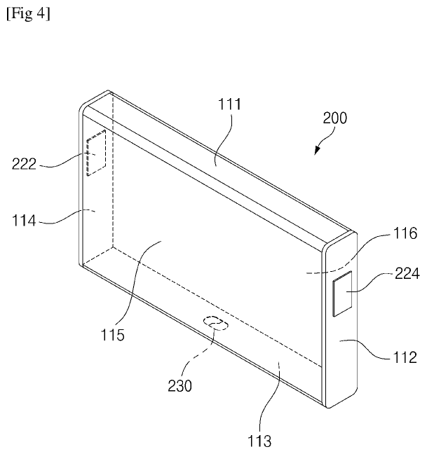

Referring to FIGS. 3 and 4, in a prismatic secondary battery 100, six flat surfaces that are first to sixth surfaces 111 to 116 constitute a hexahedral shape, and for convenience of description and understanding, the first to sixth surfaces 111 to 116 are defined as follows based on FIGS. 3 and 4. Four surfaces disposed in a clockwise direction from an upper surface will be referred to as the first to fourth surfaces 111 to 114, a front surface will be referred to as the fifth surface 115, and a rear surface will be referred to as the sixth surface 116.

FIG. 3 is a view illustrating an example of a prismatic secondary battery 200 to which an embodiment of the present invention is applicable. The prismatic secondary battery 200 of FIG. 3 corresponds to a unidirectional secondary battery in which electrode terminals 220 including a positive electrode terminal 222 and a negative electrode terminal 224 are disposed together on an upper surface (first surface 111) of a battery case 210.

A venting part 230 is disposed on a bottom surface (third surface 113) of the battery case 110. In the illustrated example, the venting part 230 is positioned on a surface farthest from the positive electrode terminal 222 and the negative electrode terminal 224. In this instance, the surface farthest from the positive electrode terminal 222 and the negative electrode terminal 224 is the bottom surface (third surface 113). The venting part 230 corresponds to a safety device which discharges gas when internal pressure of the prismatic secondary battery 200 increases to a certain level or more. For example, a notching process may be performed such that the venting part 230 has a thickness that is less than a thickness of a surrounding area, and thus the venting part 230 may be formed to be structurally weaker than the surrounding area. Accordingly, when an abnormality occurs in the prismatic secondary battery 200 and the internal pressure increases to a certain level or more, the venting part 230 is first broken so that gas generated inside the prismatic secondary battery 200 is discharged.

As discussed with reference to FIGS. 1 and 2, when the venting part 130 and the electrode terminal 120 are positioned on the same surface of the battery case 110, the electrode terminal 120 is highly likely to be damaged by corrosion, ignition, and the like when the venting part 130 is broken and internal gas is ejected. The present disclosure is directed to solving such a problem by installing the venting part 230 on a surface farthest from the positive electrode terminal 222 and the negative electrode terminal 224. This way, any discharge from the venting part 230 is ejected away from the positive electrode terminal 222 and the negative electrode terminal 224. In the case of the venting part 230 positioned at the bottom surface (third surface 113), the discharge from the venting part is towards the bottom of the prismatic secondary battery 200 due to gravity, thereby the positive electrode terminal 222 and the negative electrode terminal 224 on the upper surface (first surface 111) of a battery case 210 are protected by the battery case 210 itself. Further, the discharge being pulled to the ground by gravity prevents any discharge from making contact with the positive electrode terminal 222 and the negative electrode terminal 224 on the upper surface (first surface 111) of a battery case 210.

When the prismatic secondary battery 200 has a rectangular parallelepiped shape, the positive electrode terminal 222 and the negative electrode terminal 224 may be disposed together on a surface with the widest area excluding the front surface (fifth surface 115) and the rear surface (sixth surface 116). The venting part 130 may be disposed on the remaining widest area excluding the front surface (fifth surface 115) and the rear surface (sixth surface 116).

This is because, when the prismatic secondary battery 200 has a flat rectangular parallelepiped shape, since the greatest force acts on the front surface (fifth surface 115) and the rear surface (sixth surface 116) having the widest area (assuming that internal pressure is uniform), it is necessary to consider that, when the venting part 230 is positioned on the front and rear surfaces (fifth surface 115, sixth surface 116), the venting part 230 may be more easily ruptured than an intended design purpose by weak vibrations or disturbances.

As described above, in the prismatic secondary battery 200 of the an embodiment of the present invention, the position of the positive electrode terminal 222 and the negative electrode terminal 224 disposed on the upper surface (first surface 111) of the battery case 210 may be physically separated from the venting part 230 located on the bottom surface (third surface 113) of the battery case 210. Therefore, in the embodiment of the present invention, without a change in the internal structure of an existing prismatic secondary battery 200, the positive electrode terminal 222 and the negative electrode terminal 224 are protected from the discharge from the venting part 230, thereby reducing a development period and production costs of the prismatic secondary battery 200.

Regarding the embodiment of FIG. 3 again, the positive electrode terminal 222 and the negative electrode terminal 224 disposed on the upper surface (first surface 111) of the battery case 210 are located farthest from the venting part 230 located at the bottom surface (third surface 113) of the battery case 210. Accordingly, the positive electrode terminal 222 and the negative electrode terminal 224 are well protected from the discharge from the venting part 230.

A second embodiment of the present invention is shown in FIG. 4. FIG. 4 is a view illustrating an example of a prismatic secondary battery 200 to which the second embodiment of the present invention is applied. The illustrated prismatic secondary battery 200 corresponds to a bidirectional secondary battery 200 in which electrode terminals 220 including a positive electrode terminal 222 and a negative electrode terminal 224 are divided and each disposed on one of two side surfaces (second surface 112, fourth surface 114) of a battery case 210.

With respect to the embodiment of FIG. 4, in the prismatic secondary battery 200, the positive electrode terminal 222 and the negative electrode terminal 224 are each disposed on one of two side surfaces (second surface 112, fourth surface 114) of the battery case 210, and a venting part 230 is disposed on a bottom surface (third surface 113) of the battery case 210. This way, any discharge from the venting part 230 is ejected away from the positive electrode terminal 222 and the negative electrode terminal 224, each disposed on one of two side surfaces (second surface 112, fourth surface 114) of the battery case 210. In the case of the venting part 230 positioned at the bottom surface (third surface 113), the discharge from the venting part is towards the bottom of the prismatic secondary battery 200 due to gravity, thereby the positive electrode terminal 222 and the negative electrode terminal 224 on the respective side surfaces (second surface 112, fourth surface 114) of the battery case 210 are protected by the battery case 210 itself. Further, the discharge being pulled to the ground by gravity prevents any discharge from making contact with the positive electrode terminal 222 and the negative electrode terminal 224 on the respective side surfaces (second surface 112, fourth surface 114) of the battery case 210.

When the prismatic secondary battery 200 has a rectangular parallelepiped shape, the positive electrode terminal 222 and the negative electrode terminal 224 may be disposed at respective side surfaces (second surface 112, fourth surface 114) excluding the front surface (fifth surface 115) and the rear surface (sixth surface 116). The venting part 130 may be disposed on the bottom surface (third surface 113) excluding the front surface (fifth surface 115) and the rear surface (sixth surface 116).

This is because, when the prismatic secondary battery 200 has a flat rectangular parallelepiped shape, since the greatest force acts on the front surface (fifth surface 115) and the rear surface (sixth surface 116) having the widest area (assuming that internal pressure is uniform), it is necessary to consider that, when the venting part 230 is positioned on the front and rear surfaces (fifth surface 115, sixth surface 116), the venting part 230 may be more easily ruptured than an intended design purpose by weak vibrations or disturbances.

As described above, in the prismatic secondary battery 200 according to the embodiment, the position of the positive electrode terminal 222 and the negative electrode terminal 224 disposed on the respective side surfaces (second surface 112, fourth surface 114) of the battery case 210 may be physically separated from the venting part 230 located on the bottom surface (third surface 113) of the battery case 210. Therefore, in the embodiment, without a change in the internal structure of an existing prismatic secondary battery 200, the positive electrode terminal 222 and the negative electrode terminal 224 are protected from the discharge from the venting part 230, thereby reducing a development period and production costs of the prismatic secondary battery 200.

The disclosure discloses various embodiments of the present invention in detail through the specification and the drawings. However, the configurations described in the drawings or the embodiments in the specification are merely embodiments of the present invention and do not represent all the technical ideas of the present invention. Thus, it is to be understood that there may be various equivalents and variations in place of them at the time of filing the present application.

What is claimed is:

1. A prismatic secondary battery comprising:
a battery case including six flat surfaces that are first to sixth surfaces to form a hexahedral shape, the first and third surfaces having an area wider than the second and fourth surfaces, and the fifth and sixth surfaces having the widest area;
a positive electrode terminal and a negative electrode terminal which are disposed on at least one surface of the first, second, and fourth surfaces; and
a venting part disposed on the third surface.

2. The prismatic secondary battery of claim 1, wherein the positive electrode terminal and the negative electrode terminal which are disposed on the first surface.

3. The prismatic secondary battery of claim 1, wherein the positive electrode terminal is disposed on one of the second surface and the fourth surface, and the negative electrode terminal is disposed on a remaining of the second surface and the fourth surface.
